(19) United States
(12) Patent Application Publication
(10) Pub. No.: US 2007/0162291 A1
(43) Pub. Date: Jul. 12, 2007

(54) System and method for delivering home inspection quotes over a multi-user network

(76) Inventor: Ricardo Villadoniga Barro, Houston, TX (US)

Correspondence Address: WHITE-WELKER & WELKER, LLC, P.O. BOX 199, CLEAR SPRING, MD, 21722-0199, US

(21) Appl. No.: 11/327,960

(22) Filed: Jan. 9, 2006

(51) Int. Cl. G06Q 99/00

(52) U.S. Cl. 705/1

(57) ABSTRACT

The present invention is a website with an SQL database to provide information about home inspectors and instant home inspection quotes online with its own scheduling system and a home inspection report database enabling users, home buyers, real estate professionals, mortgage brokers, loan officers, attorneys and/or any other person to search for existence of home inspection reports on previously inspected houses/properties in the database.

### SEQUENCE LISTING OR PROGRAM

Not Applicable

### FEDERALLY SPONSORED RESEARCH

Not Applicable

### CROSS REFERENCE TO RELATED APPLICATIONS

Not Applicable

### TECHNICAL FIELD OF THE INVENTION

This invention relates to a system and method for enabling providing an electronic platform where buyers and sellers can request and view price quotes. More specifically, the present invention relates to a system and method for delivering home inspection quotes over a multi-user network.

### BACKGROUND OF THE INVENTION

The present invention is a website with an SQL database to provide information about home inspectors and instant home inspection quotes online and a home inspection report database enabling users, home buyers, real estate professionals, mortgage brokers, loan officers, attorneys and/or any other person to search for existence of home inspection reports on previously inspected houses/properties in the database.

Others have developed systems and methods for use in the real estate industry, but none have provide buyers, sellers, inspectors, and other professionals involved with real estate a single platform for scheduling, tracking, and reviewing inspections and reports about multiple properties from multiple inspectors.

U.S. Pat. No. 5,664,115 entitled “Interactive computer system to match buyers and sellers of real estate, businesses and other property using the internet” issued to Fraser on Sep. 2, 1997 teaches a method and apparatus of automatically matching sellers of property with potential buyers through a communications network (preferably the Internet) in which a host system communicates with the sellers and the potential buyers over telephone or dedicated data transmission lines. The host system obtains and stores a first set of records each corresponding to a property to be sold. The first set of records can then be search by a remote data terminal associated with a potential buyer. The results of this search are then provided to the potential buyer, who indicates specific property listings that the potential buyer may be interested in purchasing. The potential buyer provides identifying information that is then provided to the sellers of the indicated property. Provisions are made to ensure that the sellers who list property support the system. Further, the system permits automatic evaluation of potential buyers to screen buyers whose information does not match minimum criteria provided by the seller.

Real estate systems and methods taught in the prior art fail to provide a means specifically tailored to the inspection process. It is therefore an objective of the present invention to provide a system and method for online, electronic scheduling, tracking, and reporting for use by inspectors and viewing access of their clients and other approved parties.

U.S. Pat. No. 6,321,202 entitled “System and method for managing transactions relating to real estate” issued to Rave is, Jr. on Nov. 20, 2001 teaches a system and method for managing real estate transactions is provided. The method includes the steps of receiving and storing data relating to a plurality of contacts including buyers and sellers of real estate, receiving and storing data relating to a plurality of vendors each associated with at least one phase of a real estate transaction, accessing vendor data based upon occurrence of a particular phase of the real estate transaction and communicating data relating to the vendors to a contact upon occurrence of the particular phase of the real estate transaction. The system includes means for conducting each of these steps.

The prior art teaches systems and methods for tracking several aspects associated with the purchase and sale of a real estate but fail to address the inspection process. It is therefore another objective of the present invention to provide a system and method for online, electronic tracking of the inspection process for use by inspectors and their clients or other approved parties.

U.S. Pat. No. 5,794,216 entitled “Methods and system for data acquisition in a multimedia real estate database” issued to Brown on Aug. 11, 1998 teaches a device for storing information about a plurality of houses, for access by an application program executed on a computer or other like programmable apparatus, comprises a computer-readable storage medium and computer-readable data on the computer-readable storage medium. The computer-readable data is representative of a database containing textual information for each house, at least one exterior image for each house, at least one interior image for each house, and at least one parameter indicating a portion of the exterior image corresponding to the interior image for each house, all in a common database format. Methods, systems, and articles of manufacture for compiling information about a house on a computer-readable storage medium using a computer are disclosed.

Again, the prior art teaches a system for storing information that fails to provide all parties access to the information, and to provide inspectors with a platform to track their projects. It is therefore another objective of the present invention to provide a system and method for online, electronic scheduling, tracking, and reporting for use by inspectors and viewing access of their clients and other approved parties.

U.S. Pat. No. 5,748,738 entitled “System and method for electronic transmission, storage and retrieval of authenticated documents” issued to Bisbee, et al. on May 5, 1998 teaches methods and apparatus that implement digital signing and/or encryption for the electronic transmission, storage, and retrieval of authenticated documents and that enable the establishment of the identity of the originator of an electronic document and of the integrity of the information contained in such a document. Together these provide irrevocable proof of authenticity of the document. The methods and apparatus make it possible to provide “paper-less” commercial transactions, such as real-estate transactions and the financial transactions secured by real estate. A Certification Authority provides tools for initializing and managing the cryptographic material required to sign and seal electronic documents. An Authentication Center provides “third party” verification that a document is executed and transmitted by the document's originator. The methods and apparatus eliminate the need for “hard copies” of original documents as well as hard-copy storage. Retrieval of an authenticated document from the Authentication Center may be done by any number of authorized parties at any time by on-line capability.

It is known in the prior art that paperless systems for official documentation are available, but this is only one aspect of the current invention, which specifically relates to the electronic storage and transmission of certification records. It is therefore another objective of the present invention to provide a system and method for online, electronic reporting for use by inspectors and viewing access of their clients and other approved parties that provides means for issuing a certified report or decision.

U.S. Pat. No. 5,689,705 entitled “System for facilitating home construction and sales” issued to Fino, et al. on Nov. 18, 1997 teaches a system for facilitating the information transfer and processing associated with home construction and home sales. Various discrete software modules are disclosed each handling a specific task associated with home construction and sales. Also, a system for communicating between separate data bases is disclosed wherein separate and distinct sales offices, each having their own data base, may communicate with a parent, market office having its own data base wherein the data bases of the sales offices and the market office are synchronized according to the method of the present invention so that any data updates in any of the sales offices would be automatically updated in the associated market offices. This aspect of the present invention allows a corporation responsible for home construction and sales amongst various regional, market, and sales offices to coordinate a plurality of discretely separate databases in a way such that they are all synchronized with one another at a predetermined time. Prior art teaches systems used to track new construction and development of real estate, but the prior art teaches fail to provide focus on the buyer, seller, lender, and inspectors.

The prior art teaches systems for controlling costs by tracking building goods and services as described by Fino, et al. It is therefore another objective of the present invention to provide a system and method for online, electronic itemized selection of inspection details or requirements by a client for use by inspectors.

U.S. Patent Application 20030229592 entitled “System and method for collection, distribution, and use of information in connection with commercial real estate” published on Dec. 11, 2003 to Andrew, et al. teaches a system and method for creating a unified commercial real estate data model through collection, distribution and use of information in connection with commercial real estate and for creating a web-based marketplace that facilitates the efficient and secure buying and selling of commercial properties. The invention provides a digital marketplace in which the members of the commercial real estate and related business community can continuously interact and facilitate transactions by efficiently exchanging accurate and standardized information. The present invention also facilitates mortgage lending and provides enough information to allow lenders to underwrite a property. The present invention also provides a mobile data gathering and dissemination vehicle as well as a system tracking and dispatch of mobile vehicles. The present invention further provides correlation of data stored in a remote location to vehicle position in real time. This teaching does not consider the complex inspection process, and teaches away from the present invention.

It is not a goal of the present invention to provide a standardized process for scheduling, tracking, and reporting inspection results, but it is an objective of the present invention to provide a system and method for online, electronic scheduling, tracking, and reporting for use by inspectors and viewing access of their clients and other approved parties by providing a viable electronic system and method for managing the inspection process.

U.S. Patent Application 20020049624 entitled “System and method for tracking real estate transactions” published on Apr. 25, 2002 to Rave is teaches a method including the steps of generating a customer record including fields for entering an estimated completion date and an actual completion date for each of a plurality of stages of a real estate transaction; providing a customer access to the customer record over a distributed computing network to facilitate the entry, by the customer, of estimated and actual completion dates for the stages of the real estate transaction; providing a real estate agent access to the customer record over the distributed computing network to facilitate the entry, by the real estate agent, of estimated and actual completion dates for the stages of the real estate transaction; and providing a transaction coordinator access to the customer record through a server based application to facilitate the entry, by the transaction coordinator, of estimated and actual completion dates for stages of the real estate transaction in appropriate fields of the customer record.

Finally, the prior art also teaches of developing and providing a record for various stages of real estate purchases, sales, construction, and development, but has no provision for providing the scheduling or reporting features, as well as providing legitimate documentation as required by an inspection process.

It is therefore another objective of the present invention to provide a system and method for enabling an inspector to offer services, the can be specifically ordered on an itemized basis by a purchaser (buyer or seller), which means to provide electronic scheduling and reporting to all parties involved and other third-parties that are given special permission to review final reports.

### SUMMARY OF THE INVENTION

The present invention is a website with an SQL database to provide information about home inspectors and instant home inspection quotes online and a home inspection report database enabling users, home buyers, real estate professionals, mortgage brokers, loan officers, attorneys and/or any other person to search for existence of home inspection reports on previously inspected houses/properties in the database.

The present invention is embodied in the following method that comprises the steps and elements hereafter discussed in detail. First the system requires new users to register in order to obtain home inspection quotes and inspector information. New users have to create a new user record with login name and password prior to obtaining quotes. Once setup, a user is able to obtain inspector information and instant quotes online by logging on with their login name and password.

Once a record is created, a user can edit or modify the record's data as needed. Once the jobs or inspections are scheduled, a user can communicate with the selected inspector by a private message board and document all transaction details. A user will have record of all schedule jobs and detailed quotes, as desired. Additionally, a user can search for records of previously made inspections on a given property address. (Evidence if previous records will only be available if a subscriber inspector has previously made an inspection on a specific address and the inspection was scheduled through the system).

Users can find an inspector searching by Zip Code or by specifying an inspection type. A user can view the inspector's phone numbers, if available, or email address. Once an inspector has been selected, all communications can be handled by the private message board.

Alternatively, users can find an inspector by inspector last name and generate an instant online inspection quote from inspector, schedule inspection date and time, and pay online if so desired.

A user can use a discount coupon code number to search for inspector and produce an instant quote and schedule inspection date and time, and pay online if so desired.

A user is permitted to obtain multiple home inspection quotes from several inspectors simultaneously, view inspector's criteria and uploaded documentation files prior to scheduling or ordering an inspection. A user can also select more than one inspector to get a faster response. Once the inspector performs the home inspection, inspector should upload the inspection report to the system for a user to view and download if desired.

Home Inspection Quotes functionality and input data forms consist of the following SQL data tables: Appliances, Baths & Hydro-Therapy Equipment, Bedrooms, Code Certifications, Cooling System, Fireplace, Foundation Type, Garage/Carport, Heating System, Holiday Inspection, House Age, House Exterior, House Size Sq. Ft., Languages, Licenses, Membership Associations, Occupied/vacant state, Optional Inspections, Other Amenities, Others, Property Type, Specialty Inspection, House Stories, Upload Files, Water Heating Equipment. All table fields contain values used for obtaining inspection quotes and/or field validation process.

A property input table will be created by a user when a user inputs data in the search form creating a search query on the system which will find all requested items with related values. This, in turn, creates a quote from each available home inspector or technician in a specific geographic area.

Once the search process is completed, the output is displayed in a row rise window with the following data links, accessible to a user by clicking verify inspector criteria prior to selecting an inspector or technician: Inspector Phone, Inspector name, Language, Quote Price, View All Documents.

By clicking these links a user is able to view all information available from any displayed inspector prior to selection. The available inspector information should ensure a user of the inspector or technician's criteria and credibility prior to selecting the inspector. Inspectors should submit copies of visual evidence for any claimed license and/or certification including a sample copy of inspector's inspection report.

A user can select one or more inspectors that meet user required criteria and price, doing so could speed up response. The first inspector that replies is the one who will perform the job and only one inspector is able to reply for the same job or inspection.

Once the inspector is selected, the buyer will receive an online agreement with an option to click to accept to site conditions. When the buyer accepts the agreement, the payment process will begin and a user can pay for services online or onsite at the time of service.

The inspector will have the ability to view all personal transactions and invoices for service costs. The inspector or technician services are system billed online by a fix dollar amount for administrative and referral fees and by percentage of inspection quote provided by system.

The following detailed description discloses everything necessary to enable one of ordinary skill in the art to readily create and deliver a home inspection quotes to any portable electronic device, as well as sample applications, extensions and codes.

### BRIEF DESCRIPTION OF THE DRAWINGS

FIG. 1 illustrates the network of the present invention;

FIG. 2 illustrates the system functionality and method of the present invention;

FIG. 3 illustrates user site details;

FIG. 4 is a flow chart showing user options contained within the system; and

FIG. 5 illustrates inspector Site Details.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The invention is a system and method for delivering home inspection quotes over a multi-user network.

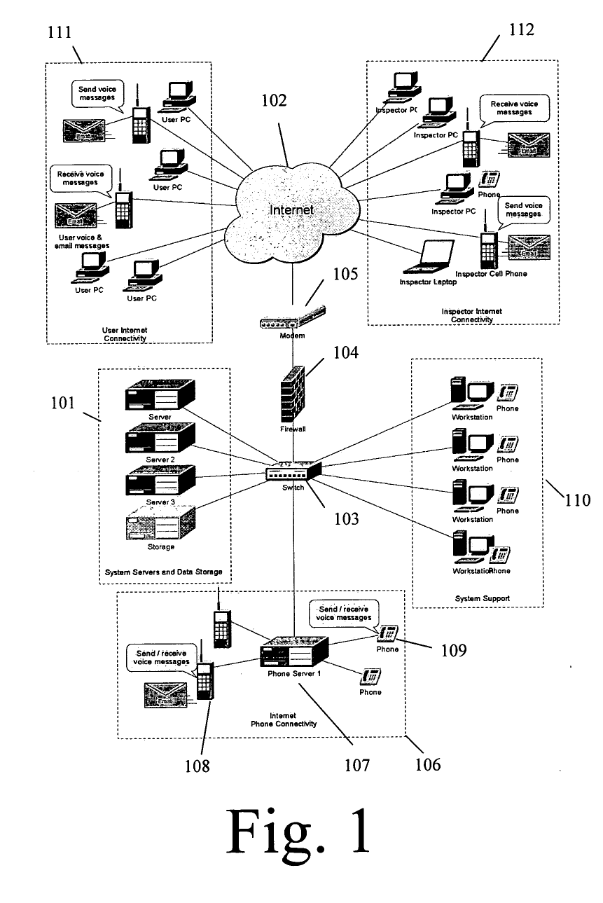

Now referring to FIG. 1 the network of the present invention is illustrated. A plurality of system servers and data storage servers 101 are first required to store the programs and information necessary to enable delivery of home inspection quotes over a multi-user network such as the Internet 102. The system servers and data storage servers 101 are connected to the Internet 102 via a switch 103, protected by a firewall 104, to a modem 105 or other access device. System support 110 is provided via one or more workstations with telephone capabilities 111.

The system of the present invention enables Internet telephone connectivity 106 via a phone server 107, connected to the switch 103, which can interface with either portable or cellular phones 108 or standard, wired telephone 109, both of which are capable of sending and receiving voice and text messages.

The system of the present invention also provides direct access to the system servers and data storage servers 101 by users and home inspectors (also referred to as inspectors) through the Internet 102. User Internet connectivity 111 and inspector Internet connectivity 112 are both enabled by telephone or electronic device access to the Internet 102.

System Functionality and Method

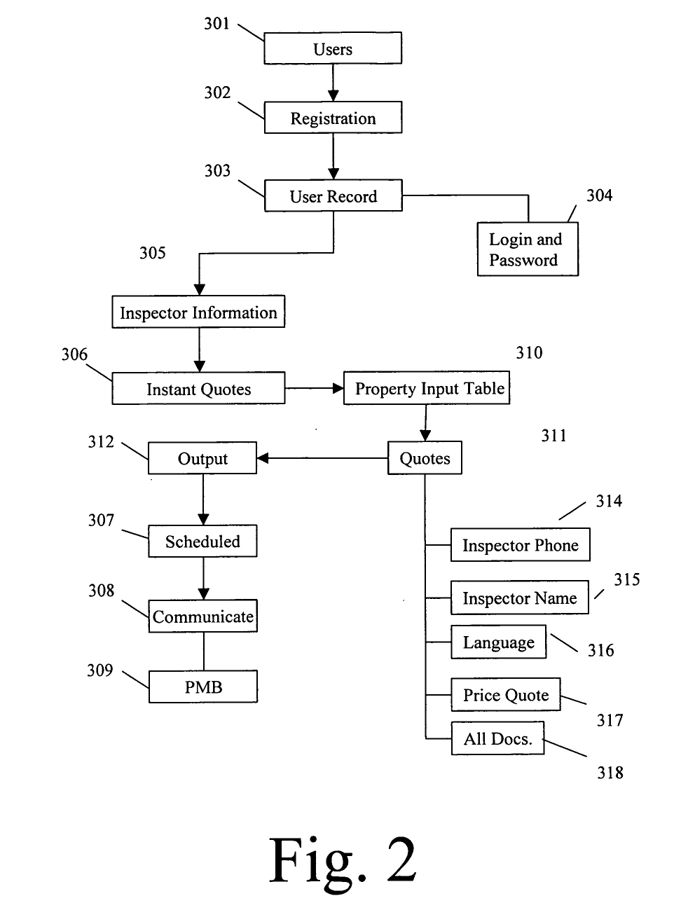

Now referring to FIG. 2, users 301 first register 302 to obtain home inspection quotes and inspector information. New users have to create a new user record 303 with login name and password 304 prior to obtaining quotes. Once setup, a user is able to obtain inspector information 305 and instant quotes 306 online by logging on with their login name and password 304. Once a record 303 is created, a user 301 can edit or modify the record's data as needed. Once the jobs or inspections are scheduled 307, a user can communicate 308 with the selected inspector by a private message board 309 and document all transaction details. As a result, a user 301 will have a record of all schedule jobs and detailed quotes, as desired.

A user 301 can search for records of previously made inspections on a given property address, but evidence of previous records will only be available if the user has scheduled and inspector has previously made an inspection on a specific address and the user inspection was scheduled through the system.

A user can find an inspector by searching by Zip Code or by specifying an inspection type. A user can view the inspector's phone numbers, if available, or email address. Once an inspector has been selected, all communications can be handled by the private message board.

Alternatively, a user can find an inspector by search for an inspector which a certain last name and generate an instant online inspection quote from the specific inspector, schedule inspection date and time, and pay online if so desired.

A user can obtain multiple home inspection quotes from several inspectors simultaneously, view inspector's criteria and uploaded documentation files prior to scheduling or ordering an inspection. A user can also select more than one inspector to get a faster response. Once an inspector performs the home inspection, inspector should upload the inspection report to the system for a user to view and download if desired.

A property input table 310 will be created by a user 301 when a user inputs data in the search form creating a search query on the system which will find all requested items with related values. This, in turn, creates a quote 311 from each available home inspector or technician in a specific geographic area. Once the search process is completed, the output 312 is displayed in a row rise window 313 with the following data to Inspector Phone 314, Inspector name 315, Language 316, Quote Price 317, View All Documents 318, accessible to a user 301 by clicking verify inspector criteria prior to selecting an inspector or technician.

By selecting any these links a user 301 is able to view all information available from any displayed inspector prior to selection. The available inspector information should ensure a user of the inspector or technician's criteria and credibility prior to selecting the inspector. Inspectors should submit copies of visual evidence for any claimed license and/or certification including a sample copy of inspector's inspection report.

A user 301 can select one or more inspectors that meet user required criteria and price, doing so could speed up response. The first inspector that replies is the one who will perform the job and only one inspector is able to reply for the same job or inspection.

Once the inspector is selected, a user (also referred to as a buyer after selection) will receive an online agreement with an option to click to accept the conditions. Once the buyer accepts the agreement, the payment process will begin and a user 301 can pay for services online or onsite at the time of service.

Inspectors will have the ability to view all personal transactions and invoices for service costs. The inspector or technician services are system billed online by a fix dollar amount for administrative and referral fees and by percentage of inspection quote provided by system.

Inspector and customer communications by phone communications server must meet with the following criteria. The system administrator or other party with administration authority must issue permission for the inspector's phone numbers be viewed online or Internet. The system administrator or other party with administration authority must setup or assign a phone and extension number to the inspector. Inspectors can use the assigned phone extension number from system phone server and have all communications routed to a number of his choice or have the system phone server take and deliver messages by email to Internet enabled phones. Customers or Internet users may call the displayed system phone number and extension and can communicate directly with an inspector or can leave a voice message that can be automatically delivered to inspector cell phone.

Finally, inspector and inspection scheduling can be fully monitored by the call center system and/or by a live person or system auto-attendants.

User/Customer/Client Site Details

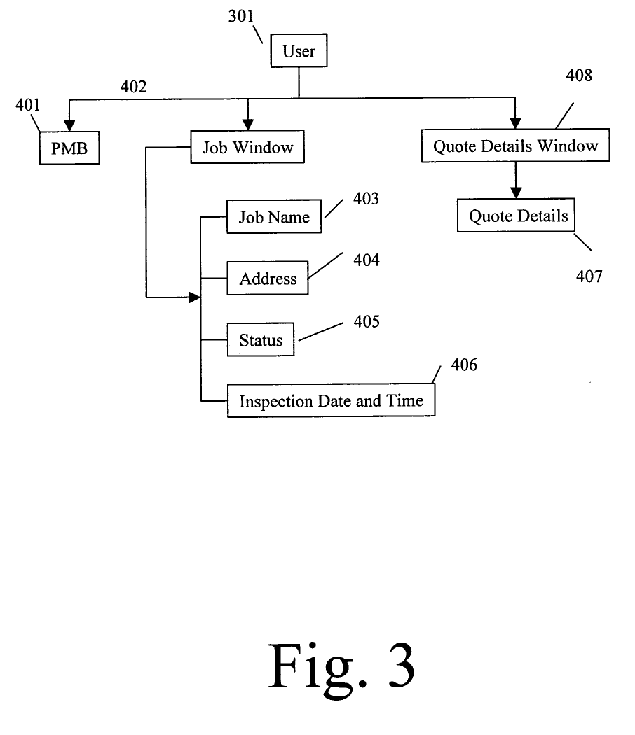

Now referring to FIG. 3 a user site details are illustrated. Once a user 301 is registered, a user 301 is able to modify or update their current information and privacy. Users 301 are able to view communications with an inspector or technician and view job details by using the personal message board 401. Via the personal message board 401 a user is able to send communication to the inspectors and once inside the view option of the message board 401, this would include any special requests or changes to the order. All messages are stored on a user's account. Additionally, a user is able to view the invoice for the job order requested once the inspector has accepted the job.

Once an inspector has accepted the job, a user is able to view details of the inspection invoice from the view job window 402 with details of any applicable discounts or reservation fees. Inspection quotes using online discount coupons will only show the discounted price on the invoice.

From the job window 402 a user is able to view job name 403, address 404, status 405, inspection date and time 405, and view quote details 406. Additionally, a user can access quote details 407 from a quote details window 408 that provides a user the ability to print the record of specific inspection item details. If there are any changes to the quote, a user can send a message to the inspector via their personal message board 401.

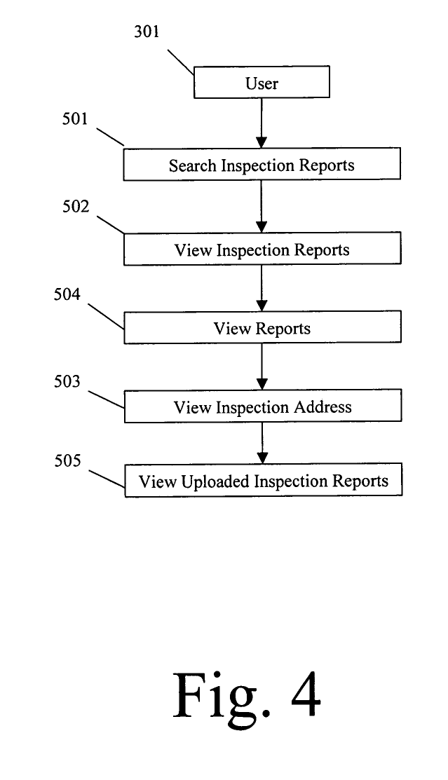

Now referring to FIG. 4, user options contained within the system are illustrated. Search Inspection Reports 501 enable a user to search for his/her previous scheduled inspections based on the subject property address. View Inspection Reports 502 allow a user to view the job name, address, inspection date and time and details of the report. The View Inspection Address 503 is accusable from the View Reports Window 504 where a user can view address details by clicking on the address.

From the View Reports Window 504, a user can download the completed inspection of once at the View Uploaded Inspection Reports 505, a user has the option to view or download their report(s).

A user is able to search the system for the applicable inspector based on the Discount Coupon Number received. A user will then be able to obtain a quote from that specific inspector, in order to take advantage of the discount. The discount will not be seen by a user until the inspector accepts the job and an invoice is created.

A user is able to obtain quotes for inspections from several inspectors based on location and the type of inspection requested. The system will automatically locate inspector based on location to the subject property. A user must input property information, desired date for inspection, time for inspection and any coupons that a user may have. The user is able to select specific licenses or certifications of the inspector.

A user is able to select specific property information—property type, house size, age of home, foundation type, number of bedrooms, number of stories and house exterior finish. Additionally, a user is able to add additional property details such as garage or carports, fireplaces, baths, cooling or heating systems and water heating systems.

A user receives quotes from several inspectors and is able to choose the inspectors to contact for inspection appointment. A user has the option to send the inspection request to as many inspectors as appears in the list. (The first inspector to reply will receive the job.)

A user can select View from the Search Results Page to obtain information on the inspector such as languages or language preference, licenses, insurance, certificates and memberships, but the inspector has the right to restrict access to personal numbers. Users are also able to view the inspector online assigned jobs through the system.

In an alternative embodiment a user is also able to view uploaded certificate, licenses, memberships, insurances and sample inspection reports. It is the intention of present invention to have inspectors upload copies of all certifications, licenses and membership that they claim.

Inspector Site Details

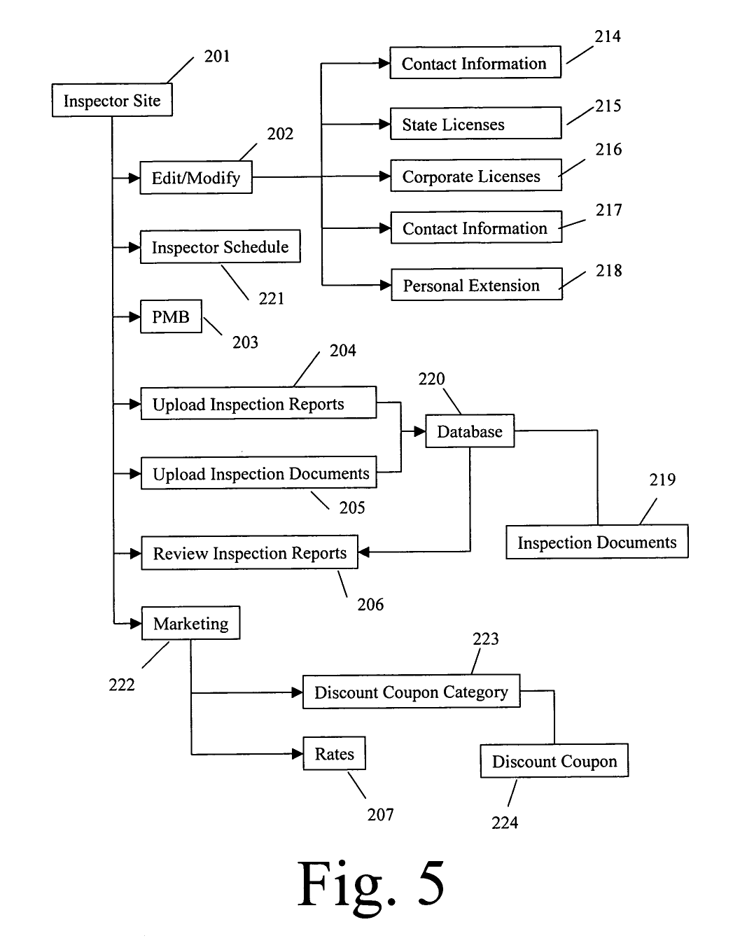

Now referring to FIG. 5, the inspector site 201 provides each inspector with their own web presence where they can upload their own information and edit or modify it as necessary 202. Inspectors have the option of entering and displaying their marketing and contact information 214. Additionally, inspectors can view, edit, and modify state licenses 215, and company licenses 216. The system will track expiration dates and provide a notice to the inspector of any upcoming or expired licenses. The system provides easily accessible information to an inspector regulatory agency such as Internet Addresses and contact information 217 as well as system information such as the main phone number and the inspector's personal extension 218. Finally, the inspector also has the option of entering and displaying insurance details such as their general liability insurer, errors and omissions, whether they are bonded, policy amounts and through whom, as well as entering electronic copies of their insurance and tracking the expiration dates of each policy.

A personal message board 203 is provided by the system for use by the inspector for enabling communication between and inspector and a plurality of clients. The personal message board includes information such as the sender's name, job name, a time stamp, a job status indicator, in addition to allowing quick access to viewing all related messages as well as associated invoices.

Inspectors have the ability to upload inspection reports 204 and inspector documents 205 as well as review inspection reports 206. Inspection reports typically contain the job name, inspection address, a status identifier and an inspection date and time. Reports can be viewed, modified, edited, and downloaded by the inspector at any time while accessing the system and permission may be set to restrict access or allow for viewing or modification by various parties.

An inspector can upload inspection documents 219 in a variety of electronic formats and store them in a database 220 for later retrieval for viewing or editing purposes. To search the document database 220, an inspector must simple query a search field for variables such as street number, street name, city, state, zip code, or county. A set of search results is then returned along with the relevant documents. Typically, the documents include the job name, inspector name, report title, inspection report upload date, and allow for email inquiry to the inspector who created or completed the inspection to inquire about more information.

The inspector site 201 includes an inspector schedule module that provides a searchable database of scheduled inspection locations, dates, and times, with detailed information. When an inspector first accesses the inspector schedule 221 a display that includes the inspector's daily schedule and a calendar is shown. If no inspection date is scheduled for a specific property, the inspector have the option to schedule an inspection date by entering a job title, work description, time, and status information to add or schedule the inspection. If an inspection date has been previously scheduled, the inspector can view the job name, address, status, inspection date and time, as well as other inspection details. The additional inspection details are hidden from view unless selected or a preference is set for their automatic display. The additional inspection details typically include the inspector name, inspection status, an option of view the price quote and details, and the house specifications and agreed upon inspection price.

The inspector site 201 also offers the option of providing home inspection marketing discount coupons 222. First an inspector must create a discount coupon category 223. Once a coupon category 223 is created the inspector can create a discount coupon 224 by selecting the discount category, and type of coupon, either percentage of quote or fixed dollar amount, in addition to setting an expiration date. An inspector can create a plurality of discount coupon categories as well as discount coupons. Discount coupons can be saved as either drafts or live/active coupons. Once a coupon enters a live status, the inspector can not modify or delete it until the expiration date has passed. An inspector can modify or delete any discount coupon that is saved in a draft status and is not currently alive or being offered. An inspector also has the option of viewing all discount categories as well as coupons in each respective category.

The information stored for each coupon typically includes the coupon number status, draft or alive, as well as any additional details as necessary or entered during creation. Coupon numbers are coded with unique inspector or technician and system data and can only be used by the creator.
(Sample code: “1 “TX” ”1836″″R″ “122″”B″″01PQ″″123105″
1 category number
TX-2 letter state abbreviation
1836-inspector license number
R-inspector first name letter initial
122-unique number, system assigned to inspector
B-inspector last name initial
01 PQ percentage of quote or fix $$ amount followed by letter FD
123105 coupon expiration date
   Final sample code 1TX1836R122B01PQ123105 as the discount number code.

The inspector site 201 also have several additional features which allow for the inspector to manage their rates 207 by increasing or decreasing their price in addition to the previously discussed temporary discounts 213. Inspectors can select from any one of multiple rate categories such as: appliances, baths, bedrooms, code certifications, cooling systems, fireplaces, foundation types, garages/carports, heating systems, holiday/weekend inspection dates, house age, house exterior, house size, languages, licenses, memberships, occupied state, option inspections, other amenities, property type, number of stories or levels, and water heating equipment. An inspector sets each category and field item along with an associated dollar value for each house item. Inspector can itemize their price chart for any number of variables including, but not limited to those discussed above.

As discussed earlier, a user inputs their category requirements and the system searches inspector databases and provides quotes to a user from multiple inspectors as selected by user based on price or geographical area.

Finally, the inspector site 201 of the system provides for further customization by allow the inspector to select spoken languages, if other than English.

It is appreciated that the relationships for the parts of the invention, to include variation in database and subsystem configuration to detach them for each other and provide the possibilities to deploy the system in different locations and under different authorities with division of labor, are deemed readily apparent and obvious to one of ordinary skill in the art, and all equivalent relationships to those illustrated in the drawings and described in the above description are intended to be encompassed by the present invention.

In addition, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for delivering home inspection quotes over a multi-user network wherein:
a plurality of system servers and data storage servers are first required to store software programs;
said system servers and data storage servers are connected to a multi-user network, via a switch protected by a firewall, and other access device;
system support is provided via one or more workstations with telephone capabilities connected to the multi-user network;
said system servers are also connected to a phone server, connected to said switch, which interfaces with either portable or cellular phones or standard, wired telephone, both of which are capable of sending and receiving voice and text messages;
a user first registers and creates a new user record comprising a login name and password;
said user is able to obtain inspector information and instant quotes;
said user first creates a record defining the inspection location and elements;
once an inspection record is created, said user can edit or modify the record's data;
upon uploading of said inspection record a property input table is created by the user whereby the user inputs data in the search form creating a search query on the system which will find all requested items with related values;
a quote is created from each available home inspector or technician in a specific geographic area;
once the search process is completed, the output results are displayed in a row rise window, accessible to a user prior to selecting an inspector or technician;
once the inspections are scheduled, a user can communicate with the selected inspector by a private message board and document all transaction details; and
once an inspector performs the inspection, said inspector should upload the inspection report to the database for a user to view and download if desired.

2. The method for delivering home inspection quotes over a multi-user network of claim 1 wherein a user can use discount coupon code number to search for an inspector to produce an instant quote and schedule inspection date and time, and pay online if so desired.

3. The method for delivering home inspection quotes over a multi-user network of claim 1 wherein a user can obtain multiple home inspection quotes from several inspectors simultaneously, view inspector's criteria and uploaded documentation files prior to scheduling or ordering an inspection.

4. The method for delivering home inspection quotes over a multi-user network of claim 1 wherein a user can also select more than one inspector.

5. The method for delivering home inspection quotes over a multi-user network of claim 4 wherein the first inspector that replies is the inspector who will perform the job and the only inspector that is able to reply for the same inspection.

6. The method for delivering home inspection quotes over a multi-user network of claim 1 wherein a user can search for records of previously made inspections on a given property address.

7. The method for delivering home inspection quotes over a multi-user network of claim 1 wherein once the inspector is selected, a user will receive an online agreement for acceptance.

8. The method for delivering home inspection quotes over a multi-user network of claim 1 wherein a user can pay for services online or onsite at the time of service.

9. The method for delivering home inspection quotes over a multi-user network of claim 8 wherein an inspector will have the ability to view all personal transactions and invoices for service costs and said inspectors services are billed over the multi-user network by a fix dollar amount for administrative and referral fees or by percentage of inspection quote provided by system.

10. The method for delivering home inspection quotes over a multi-user network of claim 1 wherein inspector and customer communications by phone communications server must meet with the following criteria:
an inspector or other party with administration authority must issue permission for the inspector's phone numbers be viewed online or Internet;
an inspector or other party with administration authority must setup or assign a phone and extension number to the inspector;
inspectors can use the assigned phone extension number from system phone server and have all communications routed to a number of his choice or have the system phone server take and deliver messages by email to Internet enabled phones;
users may call the displayed system phone number and extension and can communicate directly with an inspector or can leave a voice message that can be automatically delivered to inspector cell phone.

11. The method for delivering home inspection quotes over a multi-user network of claim 10 wherein inspection scheduling can be fully monitored by the call center system and by a live person or system auto-attendants.

12. The method for delivering home inspection quotes over a multi-user network of claim 6 wherein evidence of previous inspection records will only be available if:
the user has scheduled an inspection,
an inspector has previously made an inspection on a specific address;
and the user inspection was scheduled through the system.

13. The method for delivering home inspection quotes over a multi-user network of claim 1 wherein a user to search for previously scheduled inspections based on the subject property address.

14. The method for delivering home inspection quotes over a multi-user network of claim 1 wherein the information stored for each coupon typically includes:
the coupon number status,
draft or alive,
additional details entered during creation.

15. The method for delivering home inspection quotes over a multi-user network of claim 13 wherein coupon numbers are coded with unique inspector or technician and system data and can only be used by the creating inspector or technician.

16. The method for delivering home inspection quotes over a multi-user network of claim 14 wherein the sample code is comprised of a series of number and letters as follows:
a one category number,
a two letter state abbreviation,
an inspector license number,
a one letter inspector first name letter initial,
unique number, system assigned to inspector,
a one letter inspector last name letter initial,
a two digit percentage of quote followed by the letter PQ,
or fix dollar amount followed by letter FD,
and a coupon expiration date in the format of mm/dd/yyyy.
